(19) United States
(12) Patent Application Publication
(10) Pub. No.: US 2009/0242839 A1
(43) Pub. Date: Oct. 1, 2009

(54) Gas-phase infiltration of phosphors into the pore system of inverse opals

(76) Inventors: Holger Winkler, Darmstadt (DE); Ulrich Kynast, Muenster (DE); Marina Lezhnina, Muenster (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/293,462

(22) PCT Filed: Feb. 28, 2007
(86) PCT No.: PCT/EP2007/001733

§ 371 Date: Sep. 18, 2008

(30) Foreign Application Priority Data
Mar. 22, 2006 (DE) 10 2006 013 055.3

(51) Int. Cl. C09K 11/64; B05D 5/12

(52) U.S. Cl. 252/301.36; 427/66

(57) ABSTRACT

The invention relates to a process for the incorporation of volatile phosphors into the pore system of inverse opals by means of gas-phase infiltration, and to corresponding illuminants

The invention relates to a process for the incorporation of phosphors into the pore system of inverse opals by means of gas-phase infiltration (also known as gas-phase loading), and to corresponding illuminants.

There are highly efficient phosphors which emit red lines, such as, for example, Y₂O₃:Eu³⁺ or derivatives thereof, which contain Eu³⁺ as luminescence-active ion.

Such phosphors are employed in fluorescent lamps and other illumination systems, where the phosphor is excited at wavelengths less than 300 nm. The excitation is particularly intense at a wavelength of 254 nm (Hg plasma) or less. These phosphors can also be excited very efficiently in an electron beam, for example in CRTs (cathode ray tubes, i.e. television tubes).

However, if it were possible to excite such phosphors efficiently at blue wavelengths, for example at 450-470 nm, they could also be added to white LEDs in addition to the phosphors emitting green to orange light that are present and would facilitate a warm white light having very high efficiency (>150 lm/W) and very good colour quality (CRI>90).

Surprisingly, it has now been found that the above-mentioned phosphors can be incorporated into the interior of a photonic crystal having the structure of an inverse opal, and the phosphors located therein can be excited efficiently with blue light. This arises from the fact that blue light penetrating into the inverse opal (i.e. the light produced by the electroluminescent semiconductor, usually comprising GaN or InGaN or AlInGaN or ZnO materials, or in the case of OLEDs or PLEDs comprising blue-electroluminescent polymers) is reflected to and fro therein and thus has a very long residence time in the inverse opal. This gives rise to an interaction frequency of the blue light in the opal with the phosphors in the inverse opal which is several orders of magnitude higher than in the case of the pure phosphor, i.e. the phosphor in the inverse opal can be used for the production of highly efficient and high-quality white light in a blue LED in combination with garnet or silicate phosphors.

Light properties of this type are the prerequisite for LEDs (and OLEDs) replacing the existing light technology, such as the incandescent bulb, halogen bulb or fluorescent lamp, from 2010.

Phosphors can be incorporated into the interior of an inverse opal by means of various technological processes.

DE 102006008879.4 describes two processes in which the incorporation of the phosphors into inverse opals is carried out by solution impregnation or dispersion infiltration. Besides advantages, such as, for example, low equipment complexity, these methods also have, however, disadvantages which arise through the fact that impurities or interfering substances may be incorporated into the inverse opals through solvents. Furthermore, some phosphor precursors cannot be incorporated into the inverse opal at all by solution impregnation owing to decomposition or insolubility.

The object of the present invention was therefore to provide a further process for the incorporation of phosphors into inverse opals which avoids the disadvantages of the above-mentioned processes.

Surprisingly, this object has been achieved by a process based on so-called gas-phase infiltration.

The present invention therefore relates to a process for the preparation of a photonic material having regularly arranged cavities, comprising at least one phosphor, where
a) opal template spheres are arranged in a regular manner,
b) the sphere interstices are filled with one or more wall material precursors,
c) the wall material is formed and the opal template spheres are removed,
d) the phosphor is introduced into the cavities, with volatile phosphor precursors being introduced into the cavities of the inverse opal by means of gas-phase infiltration utilising pore diffusion,
e) the volatile precursors are converted into the phosphor in a subsequent step.

Photonic materials comprising arrangements of cavities having an essentially monodisperse size distribution in the sense of the present invention are materials which have three-dimensional photonic structures. Three-dimensional photonic structures are generally taken to mean systems which have a regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena.

The inverse structure to the opal structure (=arrangement of cavities having an essentially monodisperse size distribution) is thought to form through regular spherical hollow volumes being arranged in closest packing in a solid material. An advantage of inverse structures of this type over normal structures is the formation of photonic band gaps with dielectric constant contrasts which are already much lower (K. Busch et al. Phys. Rev. Letters E, 198, 50, 3896).

Photonic materials which have cavities must consequently have a solid wall. Suitable in accordance with the invention are wall materials which have dielectric properties and as such essentially have a non-absorbent action for the wavelength of an absorption band of the respective phosphor and are essentially transparent for the wavelength of a phosphor emission which can be stimulated by the absorption wavelength. The wall material of the photonic material should as such allow at least 95% of the radiation having the wavelength of the absorption band of the phosphor to pass through.

The matrix here essentially consists of a radiation-stable organic polymer, which is preferably crosslinked, for example an epoxy resin. In another variant of the invention, the matrix essentially consists of an inorganic material, preferably a metal chalcogenide or metal pnictide, around the cavities, where mention may be made, in particular, of silicon dioxide, aluminium oxide, zirconium oxide, iron oxides, titanium dioxide, cerium dioxide, gallium nitride, boron nitride, aluminium nitride, silicon nitride and phosphorus nitride, or mixtures thereof. It is particularly preferred in accordance with the invention for the wall of the photonic material essentially to consist of an oxide or mixed oxide of silicon, titanium, zirconium and/or aluminium, preferably of silicon dioxide.

Three-dimensional inverse structures, i.e. micro-optical systems to be employed in accordance with the invention having regular arrangements of cavities, can be produced, for example, by a template synthesis.

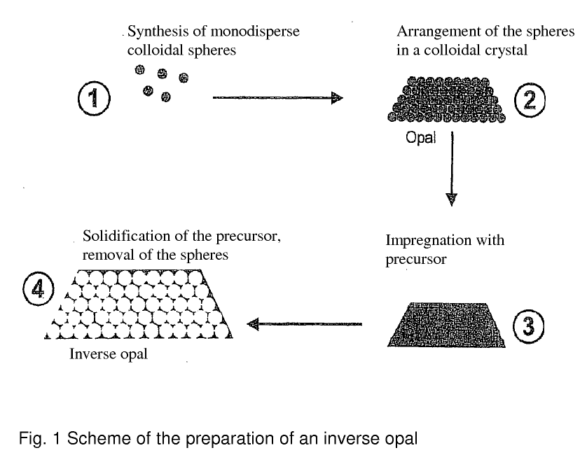

The primary building blocks used to construct inverse opals are uniform colloidal spheres (point 1 in FIG. 1). Besides further characteristics, the spheres must obey the narrowest possible size distribution (5% size deviation is tolerable). Preference is given in accordance with the invention to monodisperse PMMA spheres having a diameter in the submicron range produced by aqueous emulsion polymerisation. In the second step, the uniform colloidal spheres, after isolation and centrifugation or sedimentation, are arranged in a three-dimensional regular opal structure (point 2 in FIG. 1). This template structure corresponds to closest spherical packing, i.e. 74% of the space is filled with spheres and 26% of the space is empty (interspaces or hollow volumes). It can then be solidified by conditioning.

In the next working step (point 3 in FIG. 1), the cavities of the template are filled with a substance which forms the walls of the later inverse opal. The substance can be, for example, a solution of a precursor (preferably tetraethoxysilane). The precursor is then solidified by calcination, and the template spheres are likewise removed by calcination (point 4 in FIG. 1). This is possible if the spheres are polymers and the precursor is capable, for example, of carrying out a sol-gel reaction (transformation of, for example, silicic esters into SiO₂). After complete calcination, a replica of the template, the so-called inverse opal, is obtained.

Many such processes, which can be used for the production of cavity structures for use in accordance with the present invention, are known in the literature (for example S. G. Romanov et al., Handbook of Nanostructured Materials and Nanotechnology, Vol. 4, 2000, 231 ff.; V. Colvin et al. Adv. Mater. 2001, 13, 180; De La Rue et al. Synth. Metals, 2001, 116, 469; M. Martinelli et al. Optical Mater. 2001, 17, 11; A. Stein et al. Science, 1998, 281, 538). Core/shell particles whose shell forms a matrix and whose core is essentially solid and has an essentially monodisperse size distribution are described in DE-A-10145450. The use of core/shell particles whose shell forms a matrix and whose core is essentially solid and has an essentially monodisperse size distribution as templates for the production of inverse opal structures and a process for the production of inverse opal-like structures using such core/shell particles are described in International Patent Application WO 2004/031102. The mouldings described having homogeneous, regularly arranged cavities preferably have walls of metal oxides or of elastomers. The mouldings described are consequently either hard and brittle or exhibit an elastomeric character.

The removal of the regularly arranged template cores can be carried out by various methods. If the cores consist of suitable inorganic materials, these can be removed by etching. Silicon dioxide cores, for example, can preferably be removed using HF, in particular dilute HF solution.

If the cores in the core/shell particles are built up from a material which can be degraded by means of UV radiation, preferably a UV-degradable organic polymer, the cores are removed by UV irradiation. In this procedure too, it may in turn be preferred for crosslinking of the shell to be carried out before or after removal of the cores. Suitable core materials are then, in particular, poly(tert-butyl methacrylate), poly(methyl methacrylate), poly(n-butyl methacrylate) or copolymers which contain one of these polymers.

It may furthermore be particularly preferred for the degradable core to be thermally degradable and to consist of polymers which are either thermally depolymerisable, i.e. decompose into their monomers on exposure to heat, or for the core to consist of polymers which on degradation decompose into low-molecular-weight constituents which are different from the monomers. Suitable polymers are given, for example, in the table “Thermal Degradation of Polymers” in Brandrup, J. (Ed.: Polymer Handbook. Chichester Wiley 1966, pp. V-6-V-10, where all polymers which give volatile degradation products are suitable. The contents of this table are expressly incorporated into the disclosure content of the present application.

Preference is given here to the use of poly(styrene) and derivatives, such as poly(α-methylstyrene) or poly(styrene) derivatives which carry substituents on the aromatic ring, such as, in particular, partially or perfluorinated derivatives, poly(acrylate) and poly(methacrylate) derivatives and esters thereof, particularly preferably poly(methyl methacrylate) or poly(cyclohexyl methacrylate), or copolymers of these polymers with other degradable polymers, such as, preferably, styrene-ethyl acrylate copolymers or methyl methacrylate-ethyl acrylate copolymers, and polyolefins, polyolefin oxides, polyethylene terephthalate, polyformaldehyde, polyamides, polyvinyl acetate, polyvinyl chloride or polyvinyl alcohol.

Regarding the description of the resultant mouldings and the processes for the production of mouldings, reference is made to WO 2004/031102, the disclosure content of which is expressly incorporated into the present application.

It is particularly preferred in accordance with the invention for the average diameter of the cavities in the photonic material to be in the range about 150-600 nm, preferably in the range 250-450 nm.

The mouldings of the inverse opal are either produced directly in powder form in the corresponding processes or can be comminuted by grinding. The resultant particles can then be processed further in the sense according to the invention.

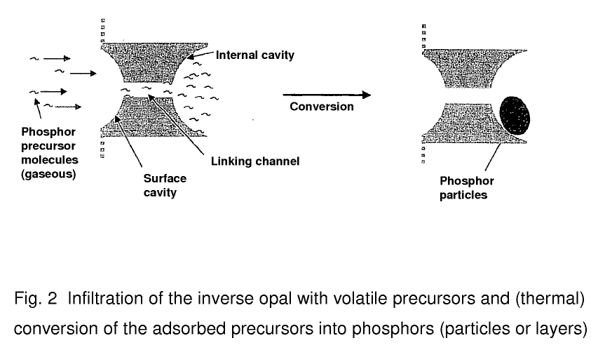

As already mentioned, the structure of the inverse opal has a porosity of 74%, enabling it to be loaded easily with further substances. The pore system of the inverse opal consists of spherical cavities (corresponding to the spheres of the template), which are connected to one another in a three-dimensional manner by a channel system (corresponds to the previous points of contact of the template spheres with one another). Phosphors or phosphor precursors which are able to pass through the linking channels (FIG. 2) can then be introduced into the interior of the opal structure.

The phosphors or phosphor precursors are introduced into the pore systems of the inverse opal powder by gas-phase infiltration utilising capillary effects.

The degree of loading or filling of the cavities with phosphors or phosphor precursors is an important criterion here. It is preferred in accordance with the invention to repeat the loading steps a number of times. It has been found here that excessively high degrees of filling of the cavities influence the photonic properties. It is therefore preferred in accordance with the invention for the cavities of the photonic material to be filled to the extent of at least 1% by vol. and at most to the extent of 50% by vol. with at least one phosphor, where the cavities are particularly preferably filled to the extent of at least 3% by vol. and at most to the extent of 30% by vol. with at least one phosphor.

For phosphors which are preferably to be employed in accordance with the invention and which have a density of about 4 g/cm³, the at least one phosphor therefore makes up 5 to 75% by weight of the photonic material, where the at least one phosphor preferably makes up 25 to 66% by weight of the photonic material.

The nanoscale phosphors can be infiltrated into the inverse opals described above if the particle size of the phosphor particles is smaller than the diameter of the linking channels between the cavities of the inverse opals.

In a preferred process variant, the phosphor can, after removal of the opal template spheres, be introduced into the cavities by means of gas-phase infiltration. This is carried out by filling the photonic material or inverse opal having regularly arranged cavities with a volatile phosphor precursor, such as, for example, acetylacetonates or fluoroacetylacetonates of the rare earths, and, depending on the phosphor, adsorbing the corresponding volatile compounds (alternatively also with carrier gases) from the internal pore system of the inverse opal in a heat-dried, evacuated inverse opal in a dynamic vacuum and at elevated temperatures. The precursors are then converted into the phosphors either by introduction of a gas (such as, for example, nitrogen or argon), followed by thermolysis and/or photolysis. The choice of suitable gas here is dependent on the type and chemical composition of the phosphor and inverse opal, as is known and familiar to the person skilled in the art.

In accordance with the invention, the infiltration of the inverse opal is carried out in a static vacuum, depending on the type of precursors, by heating a system, preferably a closed system, consisting of the heat-dried inverse opal and the precursor in such a way that the precursor is converted into the gas phase and enters the pores of the inverse opal by means of pore diffusion. When the requisite degree of loading has been reached, the system is aerated and converted into the phosphor-loaded inverse opal by thermal treatment at elevated temperatures and if necessary in a reactive-gas atmosphere (for example oxygen, forming gas or CO) or inert-gas atmosphere (argon or nitrogen).

In gas-phase technology for the coating of substrates with functional materials (for example the production of GaN-based chips for LEDs and future ZnO-based chips for LEDs), a distinction is made between CVD (=chemical vapour deposition), MOCVD (=metal organic chemical vapour deposition), MOVPE (=metal organic vapour phase epitaxy) and PVD (=physical vapour deposition).

In CVD gas-phase deposition for the production of thin layers or of particles, chemical processes occur, in contrast to the PVD process. The temperatures in this process are between 200° and 2000°. Depending on the type of energy supply, the term thermal, plasma-, photon- or laser-activated gas-phase deposition is used. The individual gas components are passed with an inert carrier gas, for example argon, at pressures between 10 mbar and 1 bar through a reaction chamber in which the chemical reaction takes place and the solid components formed in the process deposit as a thin layer or particles. The volatile by-products are discharged with the carrier gas. By means of gas-phase deposition, substrates (provided that they are stable at the temperatures) can be coated with numerous metals, semiconductors, carbides, nitrides, borides, suicides and oxides.

The PVD process encompasses vacuum coating processes for the production of thin layers or of particles in which the coating material is converted into the gas phase by purely physical methods and then deposited on the substrate. A distinction is essentially made between three process techniques:

1. In vapour deposition, the coating material is heated in a high vacuum until it is converted from the solid state via the liquid state into the gaseous state. Depending on the material, direct solid-gas conversion (sublimation) may also occur. The warming necessary is supplied via electrical resistance heating, by means of high-energy electrons or by means of laser bombardment. In addition to these proven heating techniques, the process of arc evaporation, in which the electrode material is evaporated by ignition of an electric arc between two electrodes, is constantly increasing in importance.

2. In sputtering, bombardment of a target consisting of the desired coating material with high-energy noble-gas ions results in sputtering of the surface. The ion source used is usually a noble-gas plasma. Depending on whether this is stimulated by a direct or alternating current field, the term DC sputtering or RF sputtering is used. RF sputtering also enables non-conducting materials to be sputtered.

3. Ion beams can also be used to erode the surface of the target material. This technique allows very accurate erosion and correspondingly accurate growth rates on the substrate.

The said processes are frequently combined. The commonest techniques here include plasma-supported vapour deposition or ion implantation, in which the surface is bombarded with noble-gas ions during the layer growth.

The more modern MOCVD process for the production of thin layers or particles of a material on a substrate has been employed for some years, in particular for the production of epitactic semiconductor layers. In this process, organometallic compounds and hydrides in gas form are passed into a reaction vessel (for example GaMe₃ and AsH₃ or ZnEt₂ and Te(C₃H₇)₂) and decomposed on a heated substrate so that the semiconductor material deposits thereon (for example GaAs or ZnTe). If the decomposition of the materials is additionally carried out under the influence of UV light, the term photo-MOCVD is used.

In general, all coating processes mentioned above can be employed in accordance with the invention. However, preference is given in accordance with the invention to the MOCVD process, i.e. the phosphor precursor is converted into the gas phase by chemical processes and thus incorporated as phosphor into the inverse opal.

The advantage of the gas-phase loading according to the invention consists, in particular, in simpler diffusion of the vapour or volatile precursors into the pore system of the inverse opal compared with the above-mentioned processes (for example solution impregnation) from the prior art.

It is preferred in accordance with the invention for one or more phosphor precursors and/or nanoparticulate phosphors additionally to be introduced into the sphere interstices besides the wall material precursors in step b) of the process for the preparation of a photonic material.

It is furthermore preferred for step c) of the process according to the invention to be a calcination, preferably above 200° C., particularly preferably above 400° C.

In addition, it may be particularly preferred for a gas, preferably a reactive gas, also to be added in step e) of the process according to the invention in addition to the calcination, preferably above 200° C., particularly preferably above 400° C. Reactive gases that can be employed, depending on the phosphor particles used, are, for example, H₂S, H₂/N₂, O₂, CO, etc. The choice of suitable gas here is dependent on the type and chemical composition of the phosphor and inverse opal, which is known and familiar to the person skilled in the art.

The phosphors according to the invention are preferably nanoscale phosphor particles. The phosphors here are generally composed in chemical terms of a host material and one or more dopants.

The host material can preferably comprise compounds from the group of the sulfides, selenides, sulfoselenides, oxysulfides, borates, aluminates, gallates, silicates, germanates, phosphates, halophosphates, oxides, arsenates, vanadates, niobates, tantalates, sulfates, tungstates, molybdates, alkali metal halogenates, nitrides, nitridosilicates, oxynitridosilicates, fluorides, oxyfluorides and other halides. The host materials here are preferably alkali metal, alkaline earth metal or rare-earth compounds.

The phosphor here is preferably in nanoparticulate form. Preferred particles here exhibit a mean particle size of less than 50 nm, determined as the hydraulic diameter by means of dynamic light scattering, it being particularly preferred for the mean particle diameter to be less than 25 nm.

In a variant of the invention, the light from blue light sources is to be supplemented with red components. In this case, the phosphor in a preferred embodiment of the present invention is an emitter for radiation in the range from 550 to 700 nm. The preferred dopants here include, in particular, rare-earth compounds doped with europium, samarium, terbium or praseodymium, preferably with triply positively charged europium ions.

According to one aspect of the present invention, the dopant used is furthermore one or more elements from a group comprising elements from main groups 1a, 2a or Al, Cr, Tl, Mn, Ag, Cu, As, Nb, Ni, Ti, In, Sb, Ga, Si, Pb, Bi, Zn, Co and/or elements of the so-called rare-earth metals.

A dopant pair matched to one another, for example cerium and terbium, can preferably be used, where appropriate per desired fluorescence colour, with good energy transfer, where one acts as energy absorber, in particular as UV light absorber, and the other acts as fluorescent light emitter.

In general, the material selected for the doped nanoparticles can be the following compounds, where in the following notation the host compound is indicated to the left of the colon and one or more doping elements are indicated to the right of the colon. If chemical elements are separated from one another by commas and are bracketed, their use is optional. Depending on the desired fluorescence property of the nanoparticles, one or more of the compounds available for selection can be used:
BaAl₂O₄:Eu²⁺, BaAl₂S₄:Eu²⁺, BaB₈O₃:Eu²⁺, BaF₂, BaFBr:Eu²⁺, BaFCl:Eu²⁺,
BaFCl:Eu²⁺, Pb²⁺, BaGa₂S₄:Ce³⁺, BaGa₂S₄:Eu²⁺, Ba₂Li₂Si₂O₇:Eu²⁺,
Ba₂Li₂Si₂O₇:Sn²⁺, Ba₂Li₂Si₂O₇:Sn²⁺, Mn²⁺, BaMgAl,₀O₁₇:Ce³⁺,
BaMgAl₁₀O₁₇:Eu²⁺, BaMgAl₁₀O₁₇:Eu²⁺, Mn²⁺, Ba₂Mg₃F₁₀:Eu²⁺,
BaMg₃F₈:Eu²⁺, Mn²⁺, Ba₂MgSi₂O₇:Eu²⁺, BaMg₂Si₂O₇:Eu²⁺,
Ba₅(PO₄)₃Cl:Eu²⁺, Ba₅(PO₄)₃Cl:U, Ba₃(PO₄)₂:Eu²⁺, BaS:Au, K, BaSO₄:Ce³⁺,
BaSO₄:Eu²⁺, Ba₂SiO₄:Ce³⁺, Li⁺, Mn²⁺, Ba₅SiO₄Cl₆:Eu²⁺, BaSi₂O₅:Eu²⁺,
Ba₂SiO₄:Eu²⁺, BaSi₂O₅:Pb²⁺, BaₓSri₁₋ₓF₂:Eu²⁺, BaSrMgSi₂O₇:Eu²⁺,
BaTiP₂O₇, (Ba, Ti)₂P₂O₇:Ti, Ba₃WO₆:U, BaY₂F₈Er³⁺, Yb⁺, Be₂SiO₄:Mn²⁺,
Bi₄Ge₃O₁₂, CaAl₂O₄:Ce³⁺, CaLa₄O₇:Ce³⁺, CaAl₂O₄:Eu²⁺, CaAl₂O₄:Mn²⁺,
CaAl₄O₇:Pb²⁺, Mn²⁺, CaAl₂O₄:Tb³⁺, Ca₃Al₂Si₃O₁₂:Ce³⁺,
Ca₃Al₂Si₃Oi₂:Ce³⁺, Ca₃Al₂Si₃O,₂:Eu²⁺, Ca₂B₅O₉Br:Eu²⁺,
Ca₂B₅O₉Cl:Eu²⁺, Ca₂B₅O₉Cl:Pb²⁺, CaB₂O₄:Mn²⁺, Ca₂B₂O₅:Mn²⁺,
CaB₂O₄:Pb²⁺, CaB₂P₂O₉:Eu²⁺, Ca₅B₂SiO₁₀:Eu³⁺,
Ca_{0.5}Ba_{0.5}Al₁₂O₁₉:Ce³⁺, Mn²⁺, Ca₂Ba₃(PO4)₃Cl:Eu²⁺, CaBr₂:Eu²⁺ in SiO₂,
CaCl₂:Eu²⁺ in SiO₂, CaCl₂:Eu²⁺, Mn²⁺ in SiO₂, CaF₂:Ce³⁺,
CaF₂:Ce³⁺, Mn²⁺, CaF₂:Ce³⁺, Tb³⁺, CaF₂:Eu²⁺, CaF₂:Mn²⁺, CaF₂:U,
CaGa₂O₄:Mn²⁺, CaGa₄O₇:Mn²⁺, CaGa₂S₄:Ce³⁺, CaGa₂S₄:Eu²⁺,
CaGa₂S₄:Mn²⁺, CaGa₂S₄:Pb²⁺, CaGeO₃:Mn²⁺, Cal₂:Eu²⁺ in SiO₂,
Cal₂:Eu²⁺, Mn²⁺ in SiO₂, CaLaBO₄:Eu³⁺, CaLaB₃O₇:Ce³⁺, Mn²⁺,
Ca₂La₂BO_{6.5}:Pb²⁺, Ca₂MgSi₂O₇, Ca₂MgSi₂O₇:Ce³⁺, CaMgSi₂O₆:Eu²⁺,
Ca₃MgSi₂O₈:Eu²⁺, Ca₂MgSi₂O₇:Eu²⁺, CaMgSi₂O₆:Eu²⁺, Mn²⁺,
Ca₂MgSi₂O₇:Eu²⁺, Mn²⁺, CaMoO₄, CaMoO₄:Eu³⁺, CaO:Bi³⁺, CaO:Cd²⁺,
CaO:Cu⁺, CaO:Eu³⁺, CaO:Eu³⁺, Na⁺, CaO:Mn²⁺, CaO:Pb²⁺, CaO:Sb³⁺,
CaO:Sm³⁺, CaO:Tb³⁺, CaO:Tl, CaO.Zn²⁺, Ca₂P₂O₇:Ce³⁺, α-Ca₃(PO₄)₂:Ce³⁺,
β-Ca₃(PO₄)₂:Ce³⁺, Ca₅(PO₄)₃Cl:Eu²⁺, Ca₅(PO₄)₃Cl:Mn²⁺, Ca₅(PO₄)₃Cl:Sb³⁺,
Ca₅(PO₄)₃Cl:Sn²⁺, β-Ca₃(PO₄)₂:Eu²⁺, Mn²⁺, Ca₅(PO₄)₃F:Mn²⁺,
Caₛ(PO₄)₃F:Sb³⁺, Caₛ(PO₄)₃F:Sn²⁺, α-Ca₃(PO₄)₂:Eu^{2+, β-Ca}₃(PO₄)₂:Eu²⁺,
Ca₂P₂O₇:Eu²⁺, Ca₂P₂O₇:Eu²⁺, Mn²⁺, CaP₂O₆:Mn²⁺, α-Ca₃(PO₄)₂:Pb²⁺,
α-Ca₃(PO₄)₂:Sn²⁺, β-Ca₃(PO₄)₂:Sn²⁺, β-Ca₂P₂O₇:Sn, Mn, α-Ca₃(PO₄)₂:Tr,
CaS:Bi³⁺, CaS:Bi³⁺, Na, CaS:Ce³⁺, CaS:Eu²⁺, CaS:Cu⁺, Na⁺, CaS:La³⁺,
CaS:Mn²⁺, CaSO₄:Bi, CaSO₄:Ce³⁺, CaSO₄:Ce³⁺, Mn²⁺, CaSO_{4:}EU²⁺,
CaSO₄:Eu²⁺, Mn²⁺, CaSO₄:Pb²⁺, CaS:Pb²⁺, CaS:Pb²⁺, Cl, CaS:Pb²⁺, Mn²⁺,
CaS:Pr³⁺, Pb²⁺, Cl, CaS:Sb³⁺, CaS:Sb³⁺, Na, CaS:Sm³⁺, CaS:Sn²⁺,
CaS:Sn²⁺, F, CaS:Tb³⁺, CaS:Tb³⁺, Cl, CaS:Y³⁺, CaS:Yb²⁺, CaS:Yb²⁺, Cl,
CaSiO₃:Ce³⁺, Ca₃SiO₄Cl₂:Eu²⁺, Ca₃SiO₄Cl₂:Pb²⁺, CaSiO₃:Eu²⁺,
CaSiO₃:Mn²⁺, Pb, CaSiO₃:Pb²⁺, CaSiO₃:Pb²⁺, Mn²⁺, CaSiO₃:Ti⁴⁺,
CaSr₂(PO₄)₂:Bi³⁺, β-(Ca,Sr)₃(PO₄)₂:Sn²⁺Mn²⁺, CaTi_{0.9}Al_{0.1}O₃:Bi³⁺,
CaTiO₃:Eu³⁺, CaTiO₃:Pr³⁺, Ca₅(VO₄)₃Cl, CaWO₄, CaWO₄:Pb²⁺, CaWO₄:W,
Ca₃WO₆:U, CaYAlO₄:Eu³⁺, CaYBO₄:Bi³⁺, CaYBO₄:Eu³⁺, CaYB_{0.8}O_{3.7}:Eu³⁺,
CaY₂ZrO₆:Eu³⁺, (Ca,Zn,Mg)₃(PO₄)₂:Sn, CeF₃, (Ce,Mg)BaAl₁₁O₁₈:Ce,
(Ce,Mg)SrAl₁₁O₁₈:Ce, CeMgAl₁₁O₁₉:Ce:Tb, Cd₂B₆O₁₁:Mn²⁺, CdS:Ag⁺, Cr,
CdS:In, CdS:In, CdS:In, Te, CdS:Te, CdWO₄, CsF, CsI, CsI:Na⁺, CsI:Tl,
(ErCl₃)_{0.25}(BaCl₂)_{0.75}, GaN:Zn, Gd₃Ga₅O₁₂:Cr³⁺, Gd₃Ga₅O₁₂:Cr, Ce,
GdNbO₄:Bi³⁺, Gd₂O₂S:Eu³⁺, Gd₂O₂Pr³*, Gd₂O₂S:Pr, Ce, F, Gd₂O₂S:Tb³⁺,
Gd₂SiO₅:Ce³⁺, KAl₁₁O₁₇:Tl⁺, KGa₁₁O₁₇:Mn²⁺, K₂La₂Ti₃O₁₀:Eu, KMgF₃:Eu²⁺,
KMgF₃:Mn²⁺, K₂SiF₆:Mn⁴⁺, LaAl₃B₄O₁₂:Eu³⁺, LaAlB₂O₆:Eu³⁺, LaAlO₃:Eu³⁺,
LaAlO₃:Sm³⁺, LaAsO₄:Eu³⁺, LaBr₃:Ce³⁺, LaBO₃:Eu³⁺, (La,Ce,Tb)PO₄:Ce:Tb,
LaCl₃:Ce³⁺, La₂O₃:Bi³⁺, LaOBr:Tb³⁺, LaOBr:Tm³⁺, LaOCl:Bi³⁺, LaOCl:Eu³⁺,
LaOF:Eu³⁺, La₂O₃:Eu³⁺, La₂O₃:Pr³⁺, La₂O₂S:Tb³⁺, LaPO₄:Ce³⁺, LaPO₄:Eu³⁺,
LaSiO₃Cl:Ce³⁺, LaSiO₃Cl:Ce³⁺, Tb³⁺, LaVO₄:Eu³⁺, La₂W₃O₁₂:Eu³⁺,
LiAlF₄:Mn²⁺, LiAl₅O₈:Fe³⁺, LiAlO₂:Fe³⁺, LiAlO₂:Mn²⁺, LiAl₅O₈:Mn²⁺,
Li₂CaP₂O₇:Ce³⁺, Mn²⁺, LiCeBa₄Si₄O₁₄:Mn²⁺, LiCeSrBa₃Si₄O₁₄:Mn²⁺,
LiInO₂:Eu³⁺, LiInO₂:Sm³⁺, LiLaO₂:Eu³⁺, LuAlO₃:Ce³⁺, (Lu,Gd)₂SiO₅:Ce³⁺,
Lu₂SiO₅:Ce³⁺, Lu₂Si₂O₇:Ce³⁺, LuTaO₄:Nb⁵⁺, Lu₁₋ₓYₓAlO₃:Ce³⁺,
MgAl₂O₄:Mn²⁺, MgSrAl₁₀O₁₇:Ce, MgB₂O₄:Mn²⁺, MgBa₂(PO₄)₂:Sn²⁺,
MgBa₂(PO₄)₂:U, MgBaP₂O₇:Eu²⁺, MgBaP₂O₇:Eu²⁺, Mn²⁺, MgBa₃Si₂O₈:Eu²⁺,
MgBa(SO₄)₂:Eu²⁺, Mg₃Ca₃(PO₄)₄:Eu²⁺, MgCaP₂O₇:Mn²⁺,
Mg₂Ca(SO₄)₃:Eu²⁺, Mg₂Ca(SO₄)₃:Eu²⁺, Mn², MgCeAlₙO₁₉:Tb³⁺,
Mg₄(F)GeO₆:Mn²⁺, Mg₄(F)(Ge,Sn)O₆:Mn²⁺, MgF₂:Mn²⁺, MgGa₂O₄:Mn²⁺,
Mg₈Ge₂O₁₁F₂:Mn⁴⁺, MgS:Eu²⁺, MgSiO₃:Mn²⁺, Mg₂SiO₄:Mn²⁺,
Mg₃SiO₃F₄:Ti⁴⁺, MgSO₄:Eu²⁺, MgSO₄:Pb²⁺, MgSrBa₂Si₂O₇:Eu²⁺,
MgSrP₂O₇:Eu²⁺, MgSr₅(PO₄)₄:Sn²⁺, MgSr₃Si₂O₈:Eu²⁺, Mn²⁺,
Mg₂Sr(SO₄)₃:Eu²⁺, Mg₂TiO₄:Mn⁴⁺, MgWO₄, MgYBO₄:Eu³⁺,
Na₃Ce(PO₄)₂:Tb³⁺, Nal:Tl, Na_{1.23}K_{0.42}Eu_{0.12}TiSi₄O₁₁:Eu³⁺,
Na_{1.23}K_{0.42}Eu_{0.12}TiSi₅O₁₃.xH₂O:Eu³⁺, Na_{1.29}K_{0.46}Er_{0.08}TiSi₄O₁₁:Eu³⁺,
Na₂Mg₃Al₂Si₂O₁₀:Tb, Na(Mg₂₋ₓMnₓ)LiSi₄O₁₀F₂:Mn, NaYF₄:Er³⁺, Yb³⁺,
NaYO₂:Eu³⁺, P46(70%)+P47 (30%), SrAl₁₂O₁₉:Ce³⁺, Mn²⁺, SrAl₂O₄:Eu²⁺,
SrAl₄O₇:Eu³⁺, SrAl₁₂O₁₉:Eu²⁺, SrAl₂S₄:Eu²⁺, Sr₂B₅O₉Cl:Eu²⁺,
SrB₄O₇:Eu²⁺(F,Cl,Br), SrB₄O₇:Pb²⁺, SrB₄O₇:Pb²⁺, Mn²⁺, SrB₈O₁₃:Sm²⁺,
SrₓBa_{y}Cl_{z}Al₂O_{4-z/2}:Mn²⁺, Ce³⁺, SrBaSiO₄:Eu²⁺, Sr(Cl,Br,I)₂:Eu²⁺ in SiO₂,
SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Eu²⁺, Sm²⁺,
SrF₂:Eu²⁺, SrGa₁₂O₁₉:Mn²⁺, SrGa₂S₄:Ce³⁺, SrGa₂S₄:Eu²⁺, SrGa₂S₄:Pb²⁺,
SrIn₂O₄:Pr³⁺, Al³⁺, (Sr,Mg)₃(PO₄)₂:Sn, SrMgSi₂O₆:Eu²⁺, Sr₂MgSi₂O₇:Eu²⁺,
Sr₃MgSi₂O₈:Eu²⁺, SrMoO₄:U, SrO.3B₂O₃:Eu²⁺, Cl, β-SrO.3B₂O₃:Pb²⁺,
β-SrO.3B₂O₃:Pb²⁺, Mn²⁺, α-SrO.3B₂O₃:Sm²⁺, Sr₆P₅BO₂₀:Eu,
Sr₅(PO₄)₃Cl:Eu²⁺, Sr₅(PO₄)₃Cl:Eu²⁺, Pr³⁺, Sr₅(PO₄)₃Cl:Mn²⁺,
Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺,
Sr₅(PO₄)₃F:Sb³⁺, Sr₅(PO₄)₃F:Sb³⁺, Mn²⁺, Sr₅(PO₄)₃F:Sn²⁺, Sr₂P₂O₇:Sn²⁺,
β-Sr₃(PO₄)₂:Sn²⁺, β-Sr₃(PO₄)₂:Sn²⁺, Mn²⁺(Al), SrS:Ce³⁺, SrS:Eu²⁺, SrS:Mn²⁺,
SrS:Cu⁺, Na, SrSO₄:Bi, SrSO₄:Ce³⁺, SrSO₄:Eu²⁺, SrSO₄:Eu²⁺, Mn²⁺,
Sr₅Si₄O₁₀Cl₆:Eu²⁺, Sr₂SiO₄:Eu²⁺, SrTiO₃:Pr³⁺, SrTiO₃:Pr³⁺, Al³⁺, Sr₃WO₆:U,
SrY₂O₃:Eu³⁺, ThO₂:Eu³⁺, ThO₂:Pr³⁺, ThO₂:Tb³⁺, YAl₃B₄O₁₂:Bi³⁺,
YAl₃B₄O₁₂:Ce³⁺, YAl₃B₄O₁₂:Ce³⁺, Mn, YAl₃B₄O₁₂:Ce³⁺, Tb³⁺, YAl₃B₄O₁₂:Eu³⁺,
YAl₃B₄O₁₂:Eu³⁺, Cr³⁺, YAl₃B₄O₁₂:Th⁴⁺, Ce³+, Mn²⁺, YAlO₃:Ce³⁺, Y₃Al₅O₁₂:Ce³⁺,
Y₃Al₅O₁₂:Cr³⁺, YAlO₃:Eu³⁺, Y₃Al₅O₁₂:Eu^{3r}, Y₄Al₂O₉:Eu³⁺, Y₃Al₅O₁₂:Mn⁴⁺,
YAlO₃:Sm³⁺, YAlO₃:Tb³⁺, Y₃Al₅O₁₂:Tb³⁺, YAsO₄:Eu³⁺, YBO₃:Ce³⁺,
YBO₃:Eu³⁺, YF₃:Er³⁺, Yb³⁺, YF₃:Mn²⁺, YF₃:Mn²⁺, Th⁴⁺, YF₃:Tm³⁺, Yb³⁺,
(Y,Gd)BO₃:Eu, (Y,Gd)BO₃:Tb, (Y,Gd)₂O₃:Eu³⁺, Y_{1.34}Gd_{0.60}O₃(Eu,Pr),
Y₂O₃:Bi³⁺, YOBr:Eu³⁺, Y₂O₃:Ce, Y₂O₃:Er³⁺, Y₂O₃:Eu³⁺(YOE),
Y₂O₃:Ce³⁺, Tb³⁺, YOCl:Ce³⁺, YOCl:Eu³⁺, YOF:Eu³⁺, YOF:Tb³⁺, Y₂O₃:Ho³⁺,
Y₂O₂S:Eu³⁺, Y₂O₂S:Pr³⁺, Y₂O₂S:Tb³⁺, Y₂O₃:Tb³⁺, YPO₄:Ce³⁺,
YPO₄:Ce³⁺, Tb³⁺, YPO₄:Eu³⁺, YPO₄:Mn²⁺, Th⁴⁺, YPO₄:V⁵⁺, Y(P,V)O₄:Eu,
Y₂SiO₅:Ce³⁺, YTaO₄, YTaO₄:Nb⁵⁺, YVO₄:Dy³⁺, YVO₄:Eu³⁺, ZnAl₂O₄:Mn²⁺,
ZnB₂O₄:Mn²⁺, ZnBa₂S₃:Mn²⁺, (Zn,Be)₂SiO₄:Mn²⁺, Zn_{0.4}Cd_{0.6}S:Ag,
Zn_{0.6}Cd_{0.4}S:Ag, (Zn,Cd)S:Ag, Cl, (Zn,Cd)S:Cu, ZnF₂:Mn²⁺, ZnGa₂O₄,
ZnGa₂O₄:Mn²⁺, ZnGa₂S₄:Mn²⁺, Zn₂GeO₄:Mn²⁺, (Zn,Mg)F₂:Mn²⁺,
ZnMg₂(PO₄)₂:Mn²⁺, (Zn,Mg)₃(PO₄)₂:Mn²⁺, ZnO:Al³⁺, Ga³⁺, ZnO:Bi³⁺,
ZnO:Ga³⁺, ZnO:Ga, ZnO—CdO:Ga, ZnO:S, ZnO:Se, ZnO:Zn, ZnS:Ag⁺, Cl⁻,
ZnS:Ag, Cu, Cl, ZnS:Ag, Ni, ZnS:Au, In, ZnS—CdS (25-75), ZnS—CdS (50-50),
ZnS—CdS (75-25), ZnS—CdS:Ag, Br, Ni, ZnS—CdS:Ag⁺, Cl, ZnS—CdS:Cu, Br,
ZnS—CdS:Cu, I, ZnS:Cl⁻, ZnS:Eu²⁺, ZnS:Cu, ZnS:Cu⁺, Al³⁺, ZnS:Cu⁺, Cl⁻,
ZnS:Cu, Sn, ZnS:Eu²⁺, ZnS:Mn²⁺, ZnS:Mn, Cu, ZnS:Mn²⁺, Te²⁺, ZnS:P,
ZnS:P³⁻, Cl⁻, ZnS:Pb²⁺, ZnS:Pb²⁺, Cl⁻, ZnS:Pb, Cu, Zn₃(PO₄)₂:Mn²⁺,
Zn₂SiO₄:Mn²⁺, Zn₂SiO₄:Mn²⁺, As⁵⁺, Zn₂SiO₄:Mn, Sb₂O₂, Zn₂SiO₄:Mn²⁺, P,
Zn₂SiO₄:Ti⁴⁺, ZnS:Sn²⁺, ZnS:Sn, Ag, ZnS:Sn²⁺, Li⁺, ZnS:Te, Mn, ZnS—ZnTe:Mn²⁺,
ZnSe:Cu⁺, Cl, ZnWO₄

In accordance with a further selection list, the phosphor is preferably at least one compound M^{I}₂O₃:M^{II} where M^{I}=Y, Sc, La, Gd, Lu and M^{II}=Eu, Pr, Ce, Nd, Tb, Dy, Ho, Er, Tm, Yb.

In accordance with a further selection list, the phosphor is preferably at least one compound M^{III}M^{IV}OF or M^{III}M^{IV}F₃ where M^{III}, M^{IV}=Eu, Gd, Tb.

Phosphors of this type are either commercially available or can be obtained by preparation processes known from the literature. The preparation of the fluoride- and oxyfluoride-containing phosphors is described, for example, in G. Malandrino et al. Synthesis, characterisation, and mass-transport properties of two novel gadolinium(III) hexafluoroacetylacetonate polyether adducts: promising precursors of MOCVD of GdF₃ films. Chem. Mater. 1996, 8,1292-1297.

In a preferred process variant, the phosphor, in particular in the case of fluoride- and/or oxyfluoride-containing phosphors, is employed via a volatile precursor consisting of a complex compound from the class of the diketonates MLL^{I}L^{II} where M=Eu, Gd, Tb and L, L^{I}, L^{II}=diketonato ligands of the general formula I

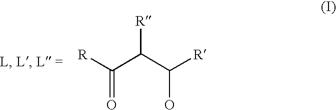

where

L, L^{I} and L^{II} may be identical to or different from one another,

R, R^{I} and R^{II} denote —H, -alkyl, -phenyl, -benzyl, -naphthyl, -pyridyl, -furyl, -thienyl, -fluoroalkyl or -perfluoroalkyl,

R, R^{I} and R^{II} may be identical to or different from one another, with the proviso that they cannot all together be —H, and further co-ligands, which are preferably multidentate.

The use of these, preferably fluorine-containing diketonato complexes as phosphor precursor has the advantage that they can be completely decomposed thermolytically or photolytically or by a combination of the two methods in the following steps, firstly to give the corresponding fluorides, and also to give the oxyfluorides in the case of the choice of a corresponding temperature and gas atmosphere (for example O₂, H₂O-saturated air). In particular, the oxyfluorides and mixtures of oxyfluorides and fluorides prove advantageous with respect to their optical properties.

It is particularly preferred for the diketonato ligands L, L^{I}, L^{II} employed in the formula I to be hexafluoroacetylacetone, phenyltrifluoroacetylacetone or thienyltrifluoroacetylacetone.

It is furthermore preferred in accordance with the invention for the diketonato complexes additionally to contain multidentate co-ligands which contain oxygen and/or nitrogen as coordinating atom.

These co-ligands are responsible for an increased vapour pressure and thus greater volatility of the complexes, which can thus be incorporated as well-defined precursors into the cavities of the inverted opals.

Particular preference is given here to the use of bidentate or tridentate co-ligands, such as, for example, bipyridines, bipyridine N-oxides, phenanthrolines or polyethers.

The phosphor precursors consisting of the diketonato complexes are then converted in full or part into fluorides or oxyfluorides of the rare earths by thermolysis and/or photolysis. Compared with pure thermolysis, a combination of photolysis and thermolysis is preferred in accordance with the invention since the latter method results in even higher emission intensities of the excited phosphors.

The thermolysis temperature must be below the temperature at which the structure of the inverse opal collapses. This temperature is between 600 and 800° C. in the case of inverse opals comprising silicon dioxide, for example, and >1000° C. in the case of corresponding materials comprising zirconium oxides or aluminium oxides.

In accordance with this objective, the present invention furthermore relates to an illuminant containing at least one light source which is characterised in that it comprises at least one photonic material prepared by the process according to the invention.

In preferred embodiments of the present invention, the illuminant is a light-emitting diode (LED), an organic light-emitting diode (OLED), a polymeric light-emitting diode (PLED) or a fluorescent lamp.

For the application which is preferred in accordance with the invention in light-emitting diodes, it is advantageous for radiation selected from the wavelength range from 250 to 500 nm to be stored in the photonic material.

The blue to violet light-emitting diodes which are particularly suitable for the invention described here include semiconductor components based on GaN (InAIGaN). Suitable GaN semiconductor materials for the production of light-emitting components are described by the general formula InᵢGaⱼAlₖN, where 0≦i, 0≦j, 0≦k and i+j+k=1. These nitride semiconductor materials thus also include substances such as indium gallium nitride and GaN. These semiconductor materials may be doped with traces of further substances, for example in order to increase the intensity or to adjust the colour of the emitted light.

Light-emitting diodes based on zinc oxide, zinc selenide and silicon carbide can also be employed in accordance with the invention.

Laser diodes (LDs) are constructed in a similar manner from an arrangement of GaN layers. Processes for the production of LEDs and LDs are well known to the persons skilled in the art in this area.

Possible configurations in which a photonic structure can be coupled to a light-emitting diode or an arrangement of light-emitting diodes are LEDs mounted in a holding frame or on the surface.

Photonic structures of this type are useful in all configurations of illumination systems which contain a primary radiation source, including, but not restricted to, discharge lamps, fluorescent lamps, LEDs, LDs (laser diodes), OLEDs and X-ray tubes. The term “radiation” in this text encompasses radiation in the UV and IR region and in the visible region of the electromagnetic spectrum. Of the OLEDs, the use of PLEDs—OLEDs comprising polymeric electroluminescent compounds—may be particularly preferred.

An example of a construction of an illumination system of this type is described in detail in EP 050174853 (Merck Patent GmbH), the disclosure content of which is expressly incorporated into the present application.

The following examples are intended to clarify the present invention. However, they should in no way be regarded as limiting. All compounds or components which can be used in the compositions are either known and commercially available or can be synthesised by known methods.

### EXAMPLES

### Example 1

### Production of a Photonic Cavity Structure Having an SiO₂ Wall and Stop Band in the Blue-Green Region of the Spectrum

Firstly, monodisperse PMMA nanospheres are produced. This is carried out with the aid of emulsifier-free, aqueous emulsion polymerisation. To this end, a 2 l double-walled stirred vessel with anchor stirrer (300 rpm stirrer speed) and reflux condenser is charged with 1260 ml of deionised water and 236 ml of methyl methacrylate, and the mixture is thermostatted at 80° C. A weak stream of nitrogen, which is able to escape via an over-pressure valve on the reflux condenser, is passed into the mixture for 1 h, before 1.18 g of azodiisobutyramidine dihydrochloride as free-radical initiator are added. The formation of the latex particles is evident through the cloudiness which immediately sets in. The polymerisation reaction is monitored thermally, with a slight increase in the temperature due to the reaction enthalpy being observed. After 2 hours, the temperature has stabilised at 80° C. again, indicating the end of the reaction. After cooling, the mixture is filtered through glass wool. Investigation of the dried dispersion using the SEM shows uniform spherical particles having a mean diameter of 317 nm.

These spheres are used as template for the production of the photonic structure. To this end, 10 g of dried PMMA spheres are suspended in deionised water and filtered through a Buchner funnel with suction.

Variant: alternatively, the dispersion resulting from the emulsion polymerisation is spun or centrifuged directly in order to allow the particles to settle in an ordered manner, the supernatant liquid is removed, and the residue is processed further as described below.

Further variant: alternatively, the dispersion resulting from the emulsion polymerisation or the sphere sediment in the dispersion can also be evaporated slowly. Further processing as described below.

The filter cake is wetted with 10 ml of a precursor solution consisting of 3 ml of ethanol, 4 ml of tetraethoxysilane, 0.7 ml of conc. HCl in 2 ml of deionised water while maintaining the suction vacuum. After the suction vacuum has been switched off, the filter cake is dried for 1 h and then calcined in a corundum container in a tubular furnace in air. The calcination is carried out in accordance with the following temperature gradients:

a) from RT to a temperature of 100° C. in 2 h, hold at 100° C. for 2 h

b) from 100° C. to a temperature of 350° C. in 4 h, hold at 350° C. for 2 h

c) from 350° C. to a temperature of 550° C. in 3 h

d) the material is treated at 550° C. for a further 14 days, subsequently

e) cooled from 550° C. to RT at 10° C./min (from 550° C. to RT in 1 h).

The resulting inverse opal powder has a mean pore diameter of about 275 nm (cf. FIG. 1). The powder particles of the inverse opal have an irregular shape with a spherical equivalent diameter of 100 to 300 μm. The cavities have a diameter of about 300 nm and are linked to one another by apertures with a size of about 60 nm.

### Example 2

### Gas-Phase Loading of an Inverse Opal with Y₂O₃:Eu³⁺

Use is made of an MOCVD unit consisting of an evaporator chamber (with nitrogen inert-gas inlet), which can be heated to a temperature of >200° C., and a tubular furnace with a quartz tube, in which is located a boat for the accommodation of the inverse opal powder, and two liquid-nitrogen-cooled cold traps after the furnace, and a downstream vacuum pump (oil-sealed rotary vane pump).

The evaporator unit is filled with the two precursors: 2 g (0.052 mol) of yttrium(III) acetylacetonate and 0.02 g (10-5 mol) of europium(III) acetyl-acetonate (ratio of 99:1). The tubular furnace, in which 200 mg of dried inverse opal powder comprising SiO₂ are located in the boat, is then heated to a temperature of 500° C., and the vacuum pump is activated. The volatile precursor mixture is subsequently infiltrated into the inverse opal in a static or dynamic vacuum and thermally converted therein into Y₂O₃:Eu.

Regarding the final process step, the volatile precursor mixture can alternatively also be infiltrated into the inverse opal in a dynamic vacuum with introduction of nitrogen carrier gas and thermally converted therein into Y₂O₃:Eu.

### Example 3

### Gas-Phase Loading of an Inverse Opal with β-diketonato Complexes of the Rare Earths (for Example Mixed Eu³⁺/Gd³⁺ Complex)

EuₓGd₍₁₋ₓ₎(hfa)₃.digly (x=0-1, hfa=hexafluoroacetylacetone, digly=diethylene glycol dimethyl ether) is prepared analogously to [1] (Gd(hfa)₃.digly). [1] G. Malandrino et al. Synthesis, characterisation, and mass-transport properties of two novel gadolinium(III) hexafluoroacetylacetonate polyether adducts: promising precursors of MOCVD of GdF₃ films. Chem. Mater. 1996, 8, 1292-1297.

0.05-0.2 g of inverse opal is dried for 3 hours at 250° C. in vacuo (10⁻³ mbar), then mixed in a glass ampoule (volume 25 ml) under argon with an amount of 0.25-1 g of EuₓGd₍₁₋ₓ₎(hfa)₃.digly. The ampoule is then melt-sealed in vacuo (10⁻³ mbar) and heated at 120° C. for 15 hours.

The products obtained in this way are shown in FIG. 1 by way of example for a composition of Eu_{0.1}Gd_{0.9}(hfa)₃.digly.

* The maximum amount of complex is calculated from: ρ_{complex}*V_{free}, where ρ_{complex}=1.912 g/ml [1], V_{free}=free volume of the weighed-out inverse opal

### Example 4

### Preparation of the Fluorides of the Rare Earths in Cavities of the Inverse Opal

The inverse opal loaded with β-diketonate complexes prepared as described in Example 3 is accommodated in a tubular furnace pre-heated to 400-600° C. and heated in this temperature regime for 0.5-2 h under dry oxygen. The decomposition can also be achieved with comparable results in a chamber furnace pre-heated to 550° C. However, the decomposition under air results in considerably lower emission intensities (see FIG. 2b).

A product decomposed from 5.5 mmol of Eu_{0.1}Gd_{0.9}(hfa)₃.digly per g of SiO₂.nH₂O and at 600° C. has the following composition after analysis by means of energy-dispersive X-ray fluorescence analysis (EDX), corresponding to LnF₃.6.4SiO₂.nH₂O (Ln:Si=1:6.4). The associated X-ray diffraction pattern (XRD) indicates hexagonal LnF₃. Besides the XRD findings, the formation of the fluorides is furthermore evident from the emission spectra of the compounds, which are typical of europium oxyfluorides (see FIG. 2).

### Example 5

### Preparation of the Oxyfluorides of the Rare Earths in Cavities of the Inverse Opal

The inverse opal loaded with β-diketonate complexes as described in Example 3 is accommodated in a chamber furnace pre-heated to 700° C. and pre-heated at this temperature over the course of 0.5-2 h and post-calcined at 600° C. for a further 3-20 h.

The conversion can likewise be carried out from the corresponding fluorides (see Example 4).

In the XRD, a mixture of LnOF and LnF₃ is evident after the pre-heating step (700° C.). Tetragonal LnOF is found after post-calcination for 5 hours and rhombohedral LnOF is found after post-calcination for 15 hours (XRD).

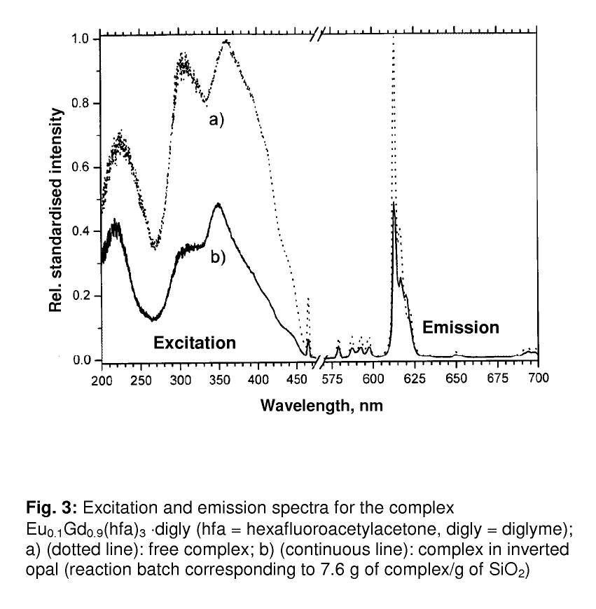

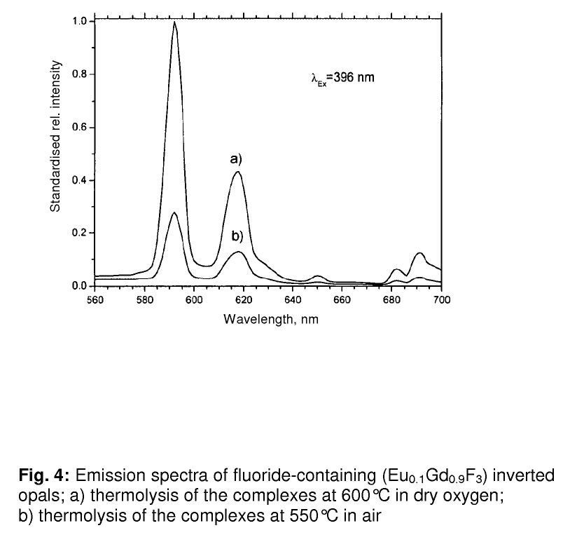

Besides the XRD findings, the formation of the oxyfluorides is furthermore evident from the emission spectra of the compounds, which are typical of europium oxyfluorides (FIG. 3a).

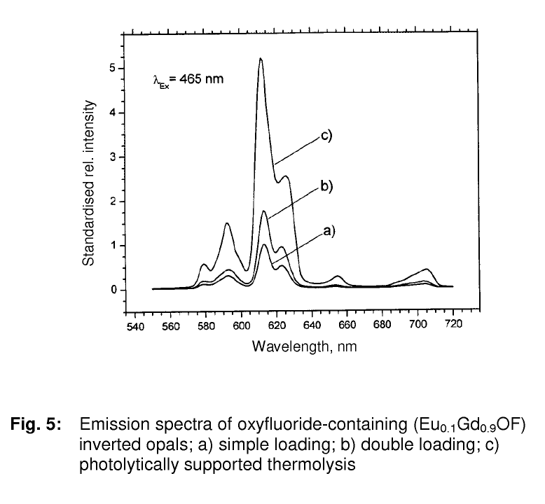

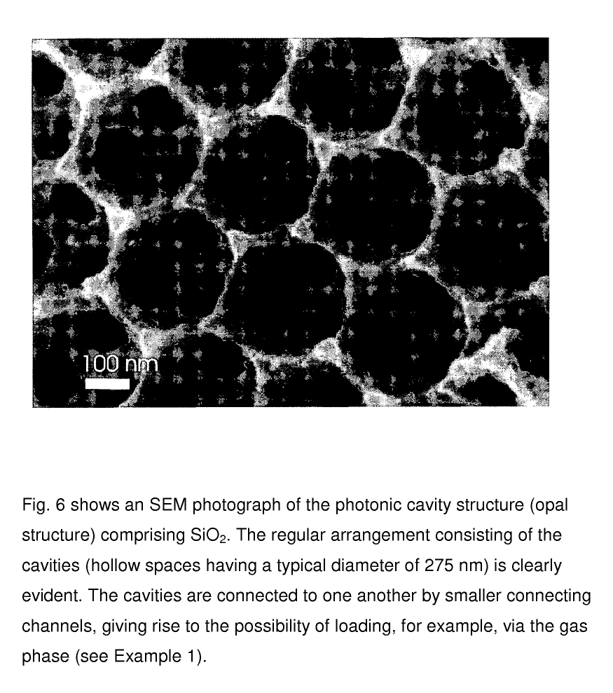

According to analysis (EDX), the product has the composition LnOF*3.2 SiO₂*nH₂O (Ln:Si=1:3.2; initial composition is 5.5 mmol of Eu_{0.1}Gd_{0.9}(hfa)₃*digly per g of SiO₂*nH₂O) (FIG. 5).

### Example 6

### Preparation of Rare-Earth Metal Oxyfluorides Having a Relatively High Oxyfluoride Content by Multiple Loading of the Inverse Opal

0.1 g of the oxyfluoride sample obtained as in Example 5 (Ln:Si=1:3.2) directly from the hot furnace is mixed with 0.1616 g (5.53×10⁻⁴ mol) of Eu_{0.1}Gd_{0.9}(hfa)₃*digly in order to prevent rehydration and re-loaded as described under Example 3 in a melt-sealed ampoule. The decomposition of the complexes is carried out as described under Example 5. The multiple loading can likewise be carried out from the corresponding fluorides (see Example 4).

According to analysis (XRD), a composition of LnOF*2.3SiO₂*nH₂O (Ln:Si=1:2.3) is obtained. The increase in the oxyfluoride content is furthermore evident from the increased emission intensity of the products (see FIG. 3b).

### Example 7

### Preparation of Rare-Earth Oxyfluorides in Inverse Opals Having a Relatively High Oxyfluoride Content by Photolysis Support

0.5-1 mm³ of a complex-containing inverse opal prepared as described in Example 3 is carefully comminuted in a mortar (0.5-1 mm³), giving an approximately 1 mm thin layer, which is photolysed over the course of 5 h under UV radiation (TQ-150 150 W UV lamp). The further decomposition is carried out at 700° C. in a pre-heated furnace for 1-20 h.

The increase in the contents by photolysis support can be achieved by repeating the procedures as described in Examples 3 to 5. According to analysis, the product has a composition corresponding to LnOF*2SiO₂*nH₂O (Ln:Si=1:2). The increase in the oxyfluoride content is evident from the increased emission intensity of the products (see FIG. 3c).

### Example 8

### Preparation of Rare-Earth Metal Oxyfluorides in Inverse Opals Having a Relatively High Oxyfluoride Content by Prior Ligand Exchange

A trifluoroacetic acid-saturated stream of oxygen is passed over the β-diketonate complex-containing inverse opal (0.5-1.5 g) in a glass tube at 80° C. for 5 h, causing conversion to rare-earth trifluoroacetates Ln(tfa)₃ (ligand exchange). The conversion is monitored by IR spectra, luminescence spectra and DTG analysis. The decomposition of the Ln(tfa)₃ complexes obtained in this way to give fluorides or oxyfluorides is carried out as before in a chamber furnace at 500° C. to 600° C. over the course of 20 h without pre-heating.

1. Process for the preparation of a photonic material having regularly arranged cavities, comprising at least one phosphor, characterised in that
a) opal template spheres are arranged in a regular manner,
b) the sphere interstices are filled with one or more wall material precursors,
c) the wall material is formed and the opal template spheres are removed,
d) the phosphor is introduced into the cavities, with volatile phosphor precursors being introduced into the cavities of the inverse opal by means of gas-phase infiltration utilising pore diffusion,
e) the volatile precursors are converted into the phosphor in a subsequent step.

2. Process according to claim 1, characterised in that one or more phosphor precursors and/or nanoparticulate phosphors are additionally introduced into the sphere interstices besides the wall material precursors in step b).

3. Process according to one of claim 1, characterised in that step c) is a calcination, preferably above 200° C., particularly preferably above 400° C.

4. Process according to claim 1 characterised in that the phosphor precursors are volatile at temperatures above room temperature and under reduced pressure.

5. Process according to claim 1 characterised in that the phosphor precursor is converted into the gas phase (MOCVD process) by chemical processes in step d).

6. Process according to claim 1 characterised in that step e) is a calcination, preferably above 200° C., particularly preferably above 400° C., where a gas may additionally also be added.

7. Process according claim 1, characterised in that the wall of the photonic material essentially consists of an oxide or mixed oxide of silicon, titanium, zirconium and/or aluminium, preferably of silicon dioxide.

8. Process according to claim 1, characterised in that the cavities of the photonic material have a diameter in the range from 150 to 600 nm.

9. Process according to claim 1, characterised in that the cavities of the photonic material are filled to the extent of at least 1% by vol. and at most to the extent of 50% by vol. with at least one phosphor, where the cavities are preferably filled to the extent of at least 3% by vol. and at most to the extent of 30% by vol. with at least one phosphor.

10. Process according to claim 1, characterised in that the at least one phosphor makes up 5 to 75% by weight of the photonic material, where the at least one phosphor preferably makes up 25 to 66% by weight of the photonic material.

11. Process according to claim 1, characterised in that the photonic material employed is a phosphor consisting of an emitter for radiation in the range 550 to 700 nm, where the emitter is a europium-, samarium-, terbium- or praseodymium-doped rare-earth compound.

12. Process according to claim 1, characterised in that the phosphor incorporated into the inverse opal is at least one compound M^{I}₂O₃:M^{II} where M^{I}=Y, Sc, La, Gd, Lu and M^{II}=Eu, Pr, Ce, Nd, Tb, Dy, Ho, Er, Tm, Yb.

13. Process according to claim 1 characterised in that the phosphor incorporated into the inverse opal is at least one compound M^{III}M^{IV}OF or M^{III}M^{IV}F₃ where M^{III}, M^{IV}=Eu, Gd, Tb.

14. Process according to claim 1 characterised in that the volatile phosphor precursor employed is at least one compound with complexes from the class of the diketonates MLL^{I}L^{II} where M=Eu, Gd, Th and L, L^{I}, L^{II}=diketonato ligands of the general formula I 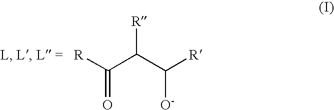
where
L, L^{I} and L^{II} may be identical to or different from one another,
R, R^{I} and R^{II} denote —H, -alkyl, -phenyl, -benzyl, -naphthyl, -pyridyl, -furyl, -thienyl, -fluoroalkyl or -perfluoroalkyl,
R, R^{I} and R^{II} may be identical to or different from one another, with the proviso that they cannot all together be —H,
and further co-ligands, which are preferably multidentate.

15. Process according to claim 13, characterised in that the diketonato ligands L, L^{I} and L^{II} employed are hexafluoroacetylacetone, phenyltrifluoroacetylacetone or thienyltrifluoroacetylacetone.

16. Process according to claim 13, characterised in that the multidentate co-ligands employed are bidentate or tridentate ligands from the group of the bipyridines, bipyridine N-oxides, phenanthrolines and polyethers.

17. Process according to claim 13, characterised in that the diketonato complexes of the phosphor precursors are converted in full or part into fluorides or oxyfluorides of the rare earths by thermolysis and/or photolysis.

18. Illuminant containing at least one light source, characterised in that it comprises at least one photonic material prepared by a process according to claim 1.

19. Illuminant according to claim 18, characterised in that the light source is an indium aluminium gallium nitride, in particular of the formula InᵢGaⱼAlₖN, where 0≦i, 0≦j, 0≦k, and i+j+k=1.

20. illuminant according to claim 18, characterised in that the light source is a compound based on ZnO.

21. Illuminant according to claim 18, characterised in that the illuminant is a light-emitting diode (LED), an organic light-emitting diode (OLED), a polymeric light-emitting diode (PLED) or a fluorescent lamp.
